(19) United States
(12) Patent Application Publication
(10) Pub. No.: US 2009/0034288 A1
(43) Pub. Date: Feb. 5, 2009

(54) LIGHT EMITTING DIODE PACKAGE, DIRECT TYPE BACKLIGHT MODULE AND EDGE TYPE BACKLIGHT MODULE

(75) Inventors: Hsin-Hua Ho, Miaoli County (TW); Wen-Jeng Hwang, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: LIGHTHOUSE TECHNOLOGY CO., LTD, Hsinchu County (TW)

(21) Appl. No.: 11/935,412

(22) Filed: Nov. 6, 2007

(30) Foreign Application Priority Data
Aug. 2, 2007 (TW) 96128414

(51) Int. Cl. F21V 8/00; G02B 5/02

(52) U.S. Cl. 362/606; 362/246; 362/355

(57) ABSTRACT

An LED package includes a carrier, an LED chip and a light scattering material. The LED chip is disposed on the carrier, electrically connected with the carrier and adapted to emitting a light with wavelength λ1. The light scattering material is disposed on the carrier and includes scatters for scattering a light. A material of the scatters is a birefringent material (e.g. barium carbonate, strontium carbonate, lithium carbonate, sodium carbonate, potassium carbonate, magnesium carbonate and so forth) or nitride (e.g. boron nitride). The present invention further provides a direct type and an edge type backlight modules whose diffusion plates have the scatters. Since the light can be scattered by the scatters, an effect of light mixing in the LED package and the uniformity of the backlight modules can be enhanced.

### CROSS-REFERENCE TO RELATED APPLICATION

This application claims the priority benefit of Taiwan application serial no. 96128414, filed on Aug. 2, 2007. All disclosure of the Taiwan application is incorporated herein by reference.

### BACKGROUND OF THE INVENTION

1. Field of the Invention

The present invention relates to a light emitting diode (LED) and a backlight module, and more particularly to an LED and a backlight module with uniform light mixing effect.

2. Description of Related Art

With continuous development of the optical technology and enhancement of modern life quality, people's demands for illumination and imaging quality of illumination equipments and displays also continually increase. Among these illumination equipments and displays, materials having scatters are usually utilized for enhancing brightness of light sources of the displays and light uniformity of the illumination equipments.

For example, since light emitting diode (LED) chips were developed to date, they have had features, such as low power consumption, low pollution, long lifespan and fast response. Thus, they have been widely applied to various filed, such as traffic lights, outdoor billboards and revolving lights. To prevent LED chips from being damaged by external environment and to enhance light extraction efficiency of LEDs, manufacturers generally fabricate the LED chips as LED packages by the packaging technology.

It should be noted that in order to uniform the light emitted from the LEDs, manufacturers generally dispose scattering materials having scatters on the LED chips so as to enhance the uniformity of the light emitted from the LED packages.

In addition, as for backlight modules of liquid crystal displays (LCDs), manufacturers generally also utilize diffusion plates having the scatters to enhance uniformity of plane light source provided by backlight modules.

It should be noted that the materials of the scatters in the prior art are nano-oxides, such as aluminum oxide, silicon oxide and titanium oxide. However, scatters of the aforementioned nano-oxides would easily cause the light extraction efficiency of the LED package to be decreased and the plane light source provided by the backlight module to be uneven.

### SUMMARY OF THE INVENTION

The present invention is directed to provide a light emitting diode (LED) package with high light extraction efficiency.

The present invention is directed to provide a direct type backlight module and an edge type backlight module capable of providing uniform plane light source.

As embodied and broadly described herein, the present invention provides an LED package including a carrier, an LED chip and a light scattering material. The LED chip is disposed on the carrier and electrically connected with the carrier. The LED chip is adapted to emitting a light with wavelength λ₁. The light scattering material is disposed on the carrier. The light scattering material includes a plurality of scatters for scattering a light. A material of the scatters is a birefringent material (e.g. barium carbonate, strontium carbonate, lithium carbonate, sodium carbonate, potassium carbonate, magnesium carbonate and so forth) or nitride (e.g. boron nitride).

In one embodiment of the present invention, the light scattering material further includes a plurality of wavelength conversion activators adapted to being excited by the light with wavelength λ₁ and then emitting a light with wavelength λ₂. A material of the wavelength conversion activators is, for example, selected from a group consisting of fluorescent material, phosphorescent material, and dye.

In one embodiment of the present invention, the LED chip includes a red, a green and a blue LED chips. The red, green and blue LED chips may be respectively driven by power from different wires so as to adjust color of the emitted light. Then, the light scattering material is further used to perform light mixing so as to enhance uniformity and brightness.

The present invention provides a direct type backlight module including a light box, a plurality of light sources and a diffusion plate. The light sources are disposed within the light box. The diffusion plate is disposed within the light box and above the light sources. The diffusion plate has a plurality of scatters for scattering light. A material of the scatters is a birefringent material (e.g. barium carbonate, strontium carbonate, lithium carbonate, sodium carbonate, potassium carbonate, magnesium carbonate, calcium carbonate) or nitride (e.g. boron nitride).

In one embodiment of the present invention, the light sources may be LEDs or cold cathode fluorescence lamps (CCFLs).

The present invention provides an edge type backlight module including a frame, a light-guide plate, a light source and a diffusion plate. The light-guide plate is disposed within the frame and has a light-incident surface and a light-emitting surface. The light source is disposed in the frame and adjacent to the light-incident surface. The diffusion plate is disposed in the frame and above the light-emitting surface. The diffusion plate has a plurality of scatters for scattering the light. A material of the scatters is a birefringent material (e.g. barium carbonate, strontium carbonate, lithium carbonate, sodium carbonate, potassium carbonate, magnesium carbonate and so forth) or nitride (e.g. boron nitride).

In one embodiment of the present invention, the light source may be a plurality of LEDs or a CCFL.

The present invention adopts a birefringent material (e.g. barium carbonate, strontium carbonate, lithium carbonate, sodium carbonate, potassium carbonate, magnesium carbonate and so forth) or nitride (e.g. boron nitride) as the scatters. When the scatters are applied to the multi-chip package, the light-mixing effect can be effectively enhanced. When the scatters are applied to the single-chip package, the brightness of the LED package can be enhanced. Therefore, in comparison with the prior art, the LED package of the present invention has better optical properties. Moreover, the direct type backlight module and the edge type backlight module of the present invention can provide a more uniform plane light source.

In order to the make the aforementioned and other objects, features and advantages of the present invention more comprehensible, several embodiments accompanied with figures are described in detail below.

### BRIEF DESCRIPTION OF THE DRAWINGS

FIG. 1 is a schematic view illustrating an LED package according to one embodiment of the present invention.

FIG. 2 is a schematic view illustrating a direct type backlight module according to one embodiment of the present invention.

FIG. 3 is a schematic view illustrating an edge type backlight module according to one embodiment of the present invention.

FIGS. 4A through 4J are schematic views illustrating other embodiments of the present invention.

### DESCRIPTION OF EMBODIMENTS

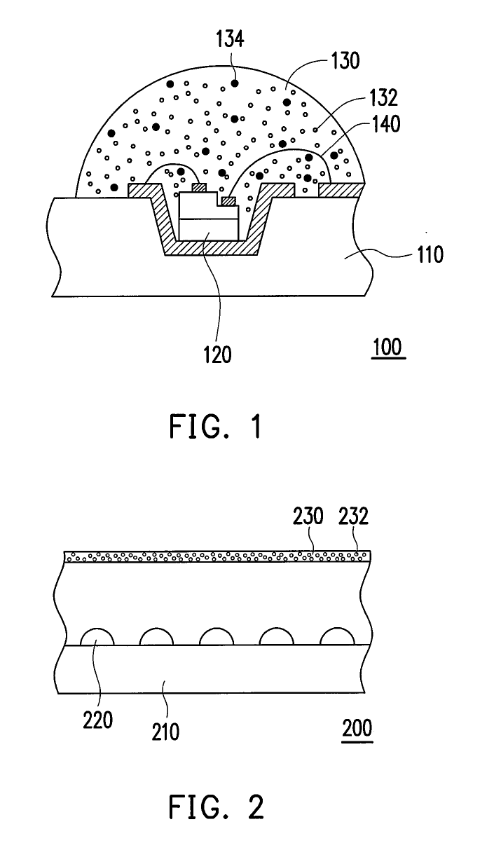

FIG. 1 is a schematic view illustrating a light emitting diode (LED) package according to one embodiment of the present invention. Referring to FIG. 1, an LED package 100 includes a carrier 110, an LED chip 120 and a light scattering material 130. In the present embodiment, the carrier 110 is a circuit board. However, in other alternative embodiments of the present invention, the carrier 100 may be a lead frame. The LED chip 120 is adapted to emitting a light with wavelength λ₁. The LED chip 120 is disposed on the carrier 110 and electrically connected with the carrier 110. In the present embodiment, the LED chip 120 is electrically connected with the carrier 110 via a plurality of bonding wires 140, for example. The light scattering material 130 is disposed on the LED chip 120. The light scattering material 130 includes a plurality of scatters 132 adapted to scattering a light. It should be noted that a material of the scatters 132 is a birefringent material (e.g. barium carbonate, strontium carbonate, lithium carbonate, sodium carbonate, potassium carbonate, magnesium carbonate and so forth) or nitride (e.g. boron nitride).

Based on the structure as described above, when the LED chip 120 is driven by applying a bias to the carrier 110, the LED chip 120 emits light with wavelength λ₁. A portion of the light is scattered by the scatters 132 while passing through the light scattering material 130. Thus, the light extraction efficiency of the LED package 100 can be enhanced via the scatters 132.

It should be noted that although the overall uniformity of the light can be enhanced by adding conventional scatters, a problem usually arises that the light extraction efficiency is reduced. Generally, conventional scatters would cause the light extraction efficiency to be reduced by more than 10%. The light scattering material 130 made of the birefringent material adopted by the present invention can not only maintain or enhance the light extraction efficiency, but also improve the uniformity of the light.

Furthermore, the light scattering material 130 of the present embodiment may further include a plurality of wavelength conversion activators 134. The material of the wavelength conversion activators 134 is selected from a group consisting of fluorescent materials, phosphorescent materials, and dye. The wavelength conversion activators 134 are adapted to being excited by the light with wavelength λ₁ and then emitting light with wavelength λ₂. When the LED chip 120 emits the light with wavelength λ₁, a portion of the light with wavelength λ₁ directly irradiates to the wavelength conversion activators 134. The other portion of the light with wavelength λ₁ irradiates to the scatters 132, and then irradiates to the wavelength conversion activator 134. Next, the wavelength conversion activators 134 are excited by the light with wavelength λ₁ and then emit light with wavelength λ₂. Thus, by mixing the two types of light with different wavelengths λ₁ and λ₂, the LED package 100 is capable of providing specific color light. For example, when λ₁ falls within a wavelength range of a blue light, and λ₂ falls within a wavelength range of a yellow light, the LED package 100 can provide a white light.

In addition, the embodiment as described above is not intended to limit the number of the LED chips of the present invention. In other embodiments of the present invention, the LED package may have more than two LED chips, and each of the LED chips is adapted to being excited so as to emit light with different wavelengths. Thus, in other embodiments of the present invention, the LED package can provide specific color light.

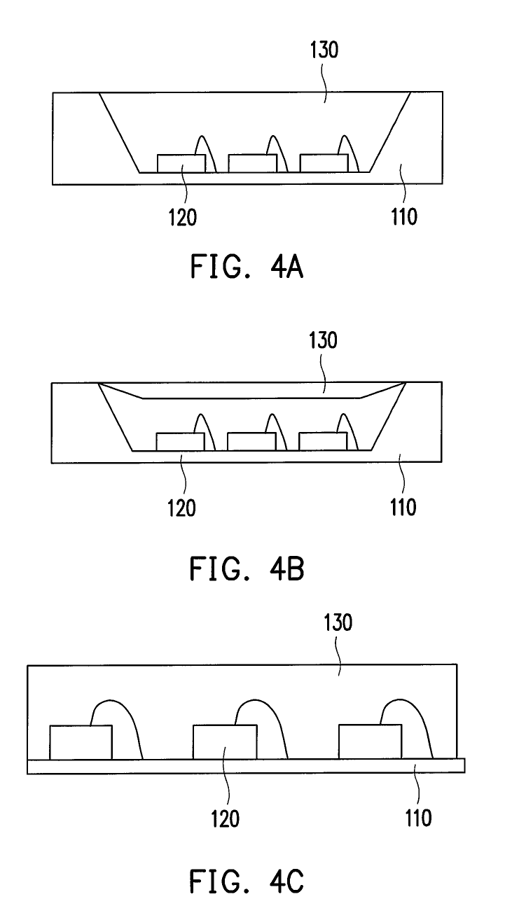

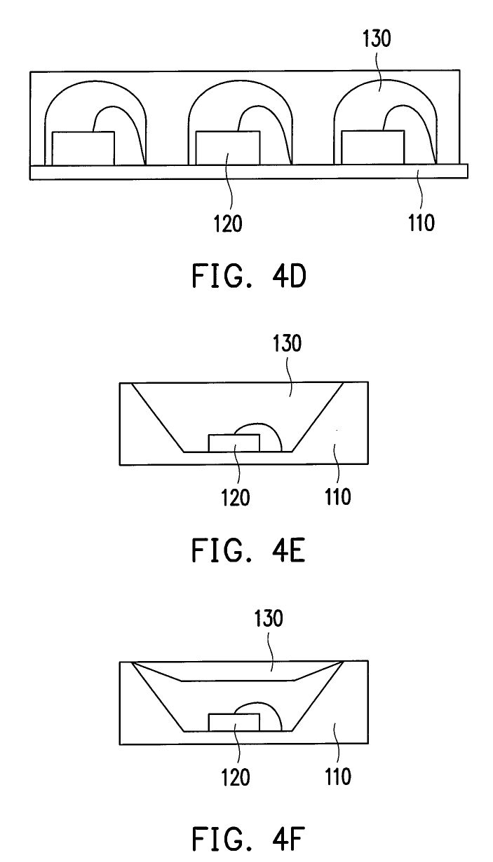

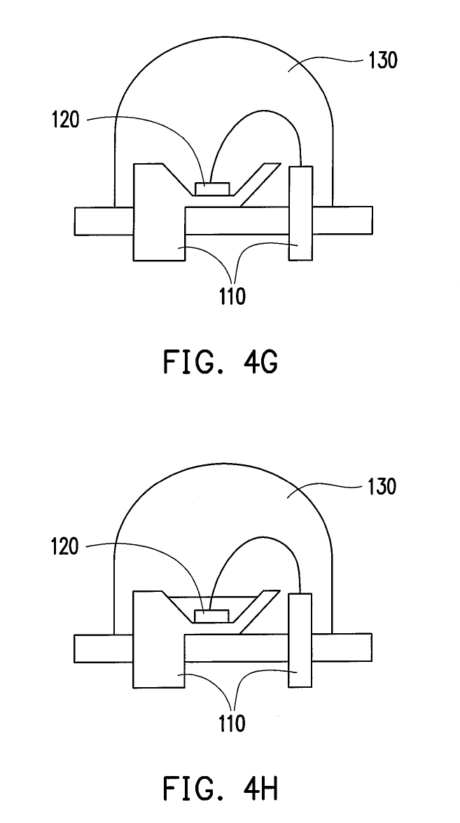

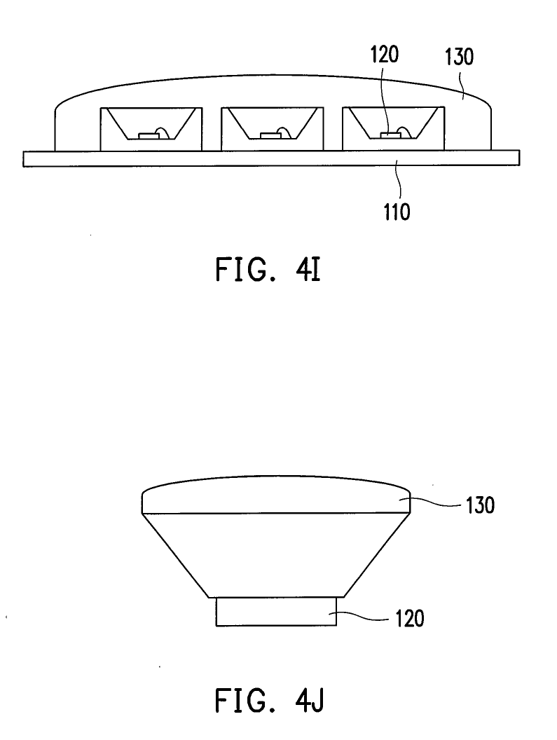

It should be noted that besides the LED package 100 illustrated in FIG. 1, the scatters 132 of the present invention can also be applied to other different types of LED packages, as shown in FIGS. 4A through 4J.

FIG. 2 is a schematic view illustrating a direct type backlight module according to one embodiment of the present invention. Referring to FIG. 2, a direct type backlight module 200 includes a light box 210, a plurality of light sources 220 and a diffusion plate 230. The light sources 220 are disposed within the light box 210. In the present embodiment, the light sources 220 are LEDs. However, in other embodiments of the present invention, the light sources 220 may be CCFLs. The diffusion plate 230 is disposed within the light box 210 and above the light sources 220. The diffusion plate 230 has a plurality of scatters 232 for scattering light. The material of the scatters 232 is a birefringent material (e.g. barium carbonate, strontium carbonate, lithium carbonate, sodium carbonate, potassium carbonate, magnesium carbonate and so forth) or nitride (e.g. boron nitride).

Thus, when the light emitted from the light sources 220 passes through the diffusion plate 230, a portion of the light directly pass through the diffusion plate 230, and another portion of the light irradiated to the surface of the scatters 232 is scattered by the scatters 232. Therefore, the direct type backlight module 200 can provide uniform plane light source.

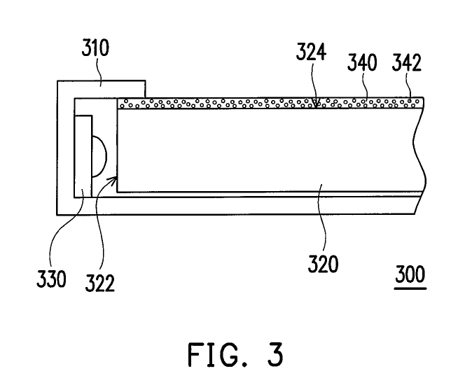

FIG. 3 is a schematic view illustrating an edge type backlight module according to one embodiment of the present invention. Referring to FIG. 3, an edge type backlight module 300 includes a frame 310, a light-guide plate 320, a light source 330 and a diffusion plate 340. The light-guide plate 320 is disposed within the frame 310 and has a light-incident surface 322 and a light-emitting surface 324. The light source 330 is disposed within the frame 310 and adjacent to the light-incident surface 322. In the present embodiment, the light source 330 includes a plurality of LEDs. In other embodiments of the present invention, the light source 330 can be a CCFL. The diffusion plate 340 is disposed within the frame 310 and above the light-emitting surface 324. The diffusion plate 340 has a plurality of scatters 342 for scattering light. The material of the scatters is a birefringent material (e.g. barium carbonate, strontium carbonate, lithium carbonate, sodium carbonate, potassium carbonate, magnesium carbonate and so forth) or nitride (e.g. boron nitride).

Thus, when light emitted from the light source 330 irradiates into the light-guide plate 320 via the light-incident surface 322 and leaves the light-guide plate 320 from the light-emitting surface 324, a portion of the light directly passes through the diffusion plate 230, and another portion of the light irradiated to the scatters 232 is scattered by the surfaces of the scatters 232. Therefore, the edge type backlight module 300 can provide a uniform plane light source.

Since the present invention adopts a birefringent material (e.g. barium carbonate, strontium carbonate, lithium carbonate, sodium carbonate, potassium carbonate, magnesium carbonate and so forth) or nitride (e.g. boron nitride) as the light scatter material, it can achieve good light extraction efficiency and reduce the distance required for light mixing. Thus, in comparison with the prior art, the LED package of the present invention has better light extraction efficiency. In the meantime, the direct type backlight module and the edge type backlight module of the present invention can provide a more uniform plane light source.

Although the present invention has been disclosed above by the embodiments, they are not intended to limit the present invention. Anyone skilled in the art can make some modifications and alteration without departing from the spirit and scope of the present invention. Therefore, the protecting range of the present invention falls in the appended claims.

What is claimed is:

1. A light emitting diode (LED) package, comprising:
a carrier;
an LED chip disposed on the carrier and electrically connected with the carrier, wherein the LED chip is adapted to emitting a light with wavelength λ₁; and
a light scattering material disposed on the carrier, the light scattering material comprising a plurality of scatters for scattering the light with wavelength λ₁, wherein a material of the scatters is a birefringent material.

2. The LED package of claim 1, wherein the birefringent material comprises barium carbonate, strontium carbonate, lithium carbonate, sodium carbonate, potassium carbonate or magnesium carbonate.

3. The LED package of claim 1, wherein the light scattering material further comprises a plurality of wavelength conversion activators adapted to being excited by the light with wavelength λ₁ and then emitting a light with wavelength λ₂.

4. The LED package of claim 3, wherein a material of the wavelength conversion activators is selected from a group consisting of fluorescent material, phosphorescent material, and dye.

5. An LED package, comprising:
a carrier;
an LED chip disposed on the carrier and electrically connected with the carrier, wherein the LED chip is adapted to emitting a light with wavelength λ₁; and
a light scattering material disposed on the LED chip, the light scattering material comprising a plurality of scatters for scattering the light with wavelength λ₁, wherein a material of the scatters is nitride.

6. The LED package of claim 5, wherein the nitride comprises boron nitride.

7. The LED package of claim 5, wherein the light scattering material further comprises a plurality of wavelength conversion activators adapted to being excited by the light with wavelength λ₁ and then emitting a light with wavelength λ₂.

8. The LED package of claim 7, wherein a material of the wavelength conversion activators is selected from a group consisting of fluorescent material, phosphorescent material, and dye.

9. A direct type backlight module, comprising:
a light box;
a plurality of light sources disposed within the light box; and
a diffusion plate disposed within the light box and above the light sources, the diffusion plate having a plurality of scatters for scattering a light emitted from the light sources, wherein a material of the scatters is a birefringent material.

10. The direct type backlight module of claim 9, wherein the birefringent material comprises barium carbonate, strontium carbonate, lithium carbonate, sodium carbonate, potassium carbonate and magnesium carbonate.

11. The direct type backlight module of claim 9, wherein the light sources comprise LEDs or cold cathode fluorescent lamps (CCFLs).

12. A direct type backlight module, comprising:
a light box;
a plurality of light sources disposed within the light box; and
a diffusion plate disposed within the light box and above the light sources, the diffusion plate having a plurality of scatters for scattering a light emitted from the light sources, wherein a material of the scatters is nitride.

13. The direct type backlight module of claim 12, wherein the nitride comprises boron nitride.

14. The direct type backlight module of claim 12, wherein the light sources are LEDs or CCFLs.

15. An edge type backlight module, comprising:
a frame;
a light-guide plate disposed within the frame, the light-guide plate having a light-incident surface and a light-emitting surface;
a light source disposed within the frame and adjacent to the light-incident surface; and
a diffusion plate disposed within the frame and above the light-emitting surface, the diffusion plate having a plurality of scatters for scattering a light emitted from the light source, wherein a material of the scatters is a birefringent material.

16. The edge type backlight module of claim 15, wherein the birefringent material comprises barium carbonate, strontium carbonate, lithium carbonate, sodium carbonate, potassium carbonate and magnesium carbonate.

17. The edge type backlight module of claim 15, wherein the light source comprises a plurality of LEDs or a CCFL.

18. An edge type backlight module, comprising:
a frame;
a light-guide plate disposed within the frame, the light-guide plate having a light-incident surface and a light-emitting surface;
a light source disposed within the frame and adjacent to the light-incident surface; and
a diffusion plate disposed within the frame and above the light-emitting surface, the diffusion plate having a plurality of scatters for scattering a light emitted from the light source, wherein a material of the scatters is nitride.

19. The edge type backlight module of claim 18, wherein the nitride comprises boron nitride.

20. The edge type backlight module of claim 18, wherein the light source comprises a plurality of LEDs or a CCFL.
